(19) United States
(12) Patent Application Publication
(10) Pub. No.: US 2023/0326465 A1
(43) Pub. Date: Oct. 12, 2023

(54) VOICE PROCESSING DEVICE, VOICE PROCESSING METHOD, RECORDING MEDIUM, AND VOICE AUTHENTICATION SYSTEM

(71) Applicant: NEC Corporation, Minato-ku, Tokyo (JP)

(72) Inventor: Hitoshi Yamamoto, Tokyo (JP)

(73) Assignee: NEC Corporation, Minato-ku, Tokyo (JP)

(21) Appl. No.: 18/023,556

(22) PCT Filed: Aug. 31, 2020
(86) PCT No.: PCT/JP2020/032952

§ 371 Date: Feb. 27, 2023

(51) Int. Cl. G10L 17/20; G10L 17/02; G10L 17/18; G10L 25/18

(52) U.S. Cl. CPC G10L 17/20; G10L 17/02; G10L 17/18; G10L 25/18

(57) ABSTRACT

The present disclosure implements speaker verification with high accuracy regardless of input devices. An integration unit (110) integrates voice data inputted using an input device, and the frequency characteristic of the input device, and a feature extraction unit (120) extracts, from an integrated feature obtained by integrated the voice data and the frequency characteristic, a speaker feature for verifying the speaker of voice.

### TECHNICAL FIELD

The present disclosure relates to a voice processing device, a voice processing method, a recording medium, and a voice authentication system, and more particularly to a voice processing device, a voice processing method, a recording medium, and a voice authentication system that verify a speaker based on voice data input via an input device.

### BACKGROUND ART

In a related technique, a speaker is verified by comparing the feature of a voice included in first voice data with the feature of a voice included in second voice data. Such a related technique is called verification or speaker verification by voice authentication. In recent years, speaker verification has been increasingly used in tasks requiring remote conversation, such as construction sites and factories.

PTL 1 describes that speaker verification is performed by obtaining a time-series feature amount by performing frequency analysis on voice data and comparing a pattern of the obtained feature amount with a pattern of a feature amount registered in advance.

In a related technique described in PTL 2, the feature of a voice input using an input device such as a microphone for a call included in a smartphone or a headset microphone is compared with the feature of a voice registered using another input device. For example, the feature of a voice registered using a tablet in an office is compared with the feature of a voice input from a headset microphone at a site.

### CITATION LIST

### Patent Literature

[PTL 1] JP 07-084594 A

[PTL 2] JP 2016-075740 A

### SUMMARY OF INVENTION

### Technical Problem

When the input device used at the time of registration and the input device used at the time of verification are different, a range of frequency of the sensitivity is different between these input devices. In such a case, the personal verification rate decreases as compared with a case where the same input device is used at both the time of registration and the time of verification. As a result, there is a high possibility that speaker verification fails.

The present disclosure has been made in view of the above problem, and an object thereof is to achieve highly accurate speaker verification regardless of an input device.

### Solution to Problem

A voice processing device according to an aspect of the present disclosure includes: an integration means configured to integrate voice data input by using an input device and a frequency response of the input device; and a feature extraction means configured to extract a speaker feature for verifying a speaker of the voice data from an integrated feature obtained by integrating the voice data and the frequency response.

A voice processing method according to an aspect of the present disclosure includes: integrated voice data input by using an input device and a frequency response of the input device; and extracting a speaker feature for verifying a speaker of the voice data from an integrated feature obtained by integrating the voice data and the frequency response.

A recording medium according to an aspect of the present disclosure stores a program for causing a computer to execute: processing of integrated voice data input by using an input device and a frequency response of the input device; and processing of extracting a speaker feature for verifying a speaker of the voice data from an integrated feature obtained by integrating the voice data and the frequency response.

A voice authentication system according to an aspect of the present disclosure includes: the voice processing device according to an aspect of the present disclosure; and a verification device that checks whether the speaker is a registered person himself/herself based on the speaker feature output from the voice processing device.

### Advantageous Effects of Invention

According to one aspect of the present disclosure, highly accurate speaker verification can be achieved regardless of an input device.

### BRIEF DESCRIPTION OF DRAWINGS

FIG. 1 is a block diagram illustrating a configuration of a voice authentication system common to all example embodiments.

FIG. 2 is a block diagram illustrating a configuration of a voice processing device according to a first example embodiment.

FIG. 3 is a graph illustrating an example of frequency dependence (frequency response) of sensitivity for an input device.

FIG. 4 illustrates a characteristic vector obtained from an example of a frequency response of an input device.

FIG. 5 is a diagram describing a flow in which a feature extraction unit according to the first example embodiment obtains a speaker feature from an integrated feature using a DNN.

FIG. 6 is a flowchart illustrating an operation of the voice processing device according to the first example embodiment.

FIG. 7 is a block diagram illustrating a configuration of a voice processing device according to a second example embodiment.

FIG. 8 is a flowchart illustrating an operation of the voice processing device according to the second example embodiment.

FIG. 9 is a diagram illustrating a hardware configuration of the voice processing device according to the first example embodiment or the second example embodiment.

### EXAMPLE EMBODIMENT

### Common to All Example Embodiments

First, an example of a configuration of a commonly applied voice authentication system according to all example embodiments described below will be described.

### Speech Authentication System 1

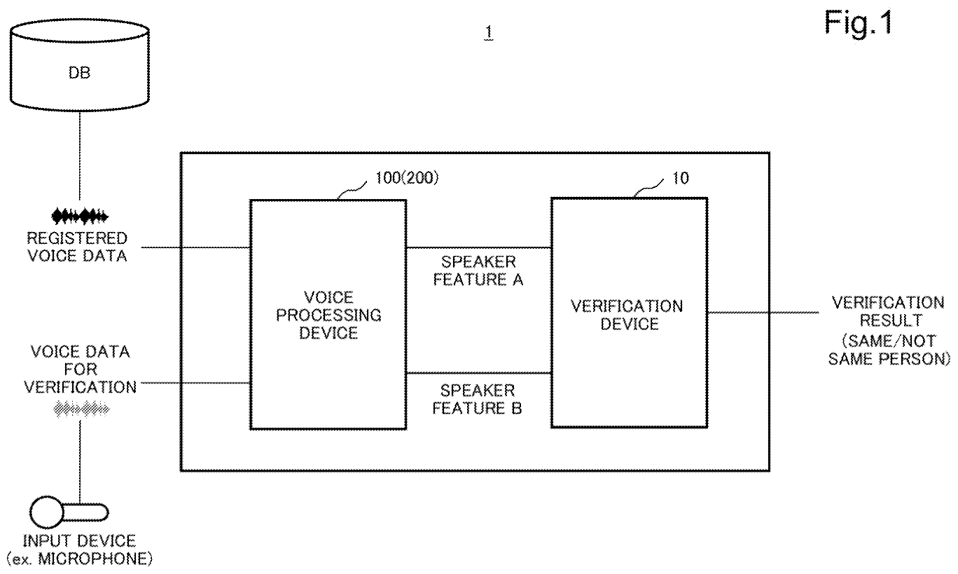

An example of a configuration of a voice authentication system 1 will be described with reference to FIG. 1. FIG. 1 is a block diagram illustrating an example of a configuration of the voice authentication system 1.

As illustrated in FIG. 1, the voice authentication system 1 includes a voice processing device 100(200) and a verification device 10. The voice authentication system 1 may include one or a plurality of input devices. The voice processing device 100(200) is the voice processing device 100 or the voice processing device 200.

Processing and operations executed by the voice processing device 100(200) will be described in detail in the first and second example embodiments described below. The voice processing device 100(200) acquires voice data (hereinafter, referred to as registered voice data) of a speaker (person A) registered in advance from a data base (DB) on a network or from a DB connected to the voice processing device 100(200). The voice processing device 100(200) acquires, from the input device, voice data (hereinafter, referred to as voice data for verification) of an object (person B) to be verified. The input device is used to input a voice to the voice processing device 100(200). In one example, the input device is a microphone for a call included in a smartphone or a headset microphone.

The voice processing device 100(200) generates speaker feature A based on the registered voice data. The voice processing device 100(200) generates speaker feature B based on the voice data for verification. The speaker feature A is obtained by integrated the registered voice data registered in the DB and the frequency response of the input device used to input the registered voice data. The acoustic feature is a feature vector having one or a plurality of feature amounts (hereinafter, may be referred to as a first parameter) that is a numerical value quantitatively representing the feature of the registered voice data as an element. The device feature is a feature vector having one or a plurality of feature amounts (hereinafter, may be referred to as a second parameter) that is a numerical value quantitatively representing the feature of the input device as an element. The speaker feature B is obtained by integrating the voice data for verification input using the input device and the frequency response of the input device used to input the voice data for verification.

The two-step processing below is referred to as “integration” of the voice data (registered voice data or voice data for verification) and the frequency response of the input device. Hereinafter, the registered voice data or the voice data for verification will be referred to as registered voice data/voice data for verification. The first step is to extract an acoustic feature related to the frequency response of the registered voice data/voice data for verification and to extract the device feature related to the frequency response of the sensitivity of the input device used for inputting. The second step is to concatenate both the acoustic feature and the device feature. Concatenating is to break down the acoustic feature into its element, a first parameter, break down the device feature into its element, a second parameter, and generate a feature vector including both the first parameter and the second parameter as mutually independent dimensional elements. As described above, the first parameter is a feature amount extracted from the frequency response of the registered voice data/voice data for verification. The second parameter is a feature amount extracted from the frequency response of the sensitivity of the input device used to input the registered voice data/voice data for verification. In this case, concatenation is to generate a (n+m)-dimensional feature vector having, as elements, n feature amounts that are the first parameter constituting the acoustic feature and m feature amounts that are the second parameter constituting the device feature (n and m are each an integer).

Thus, one feature (hereinafter, referred to as integrated feature) that depends on both the frequency response of the registered voice data/voice data for verification and the frequency response of the sensitivity of the input device used to input the registered voice data/voice data for verification can be obtained. The integrated feature is a feature vector having a plurality of (n+m, in the above example) feature amounts as an element.

The meaning of the integration in each example embodiment described below is the same as the meaning described here.

The acoustic feature is extracted from the registered voice data and the voice data for verification. On the other hand, the device feature is extracted from data related to the input device (in one example, data indicating the frequency response of the sensitivity of the input device). Then, the voice processing device 100(200) transmits the speaker feature A and the speaker feature B to the verification device 10.

The verification device 10 receives the speaker feature A and the speaker feature B from the voice processing device 100(200). The verification device 10 checks whether the speaker is a registered person himself/herself based on the speaker feature A and the speaker feature B output from the voice processing device 100(200). More specifically, the verification device 10 compares the speaker feature A with the speaker feature B, and outputs a verification result. That is, the verification device 10 outputs information indicating whether the person A and the person B are the same person.

The voice authentication system 1 may include a control device (control function) that controls an electronic lock of a door for entering an office, automatically activates or logs on an information terminal, or permits access to information on an intra-network based on a verification result output by the verification device 10.

The voice authentication system 1 may be achieved as a network service. In this case, the voice processing device 100(200) and the verification device 10 may be on a network and communicable with one or a plurality of input devices via a wireless network.

Hereinafter, a specific example of the voice processing device 100(200) included in the voice authentication system 1 will be described. In the description below, “voice data” refers to both “registered voice data” and “voice data for verification”.

### First Example Embodiment

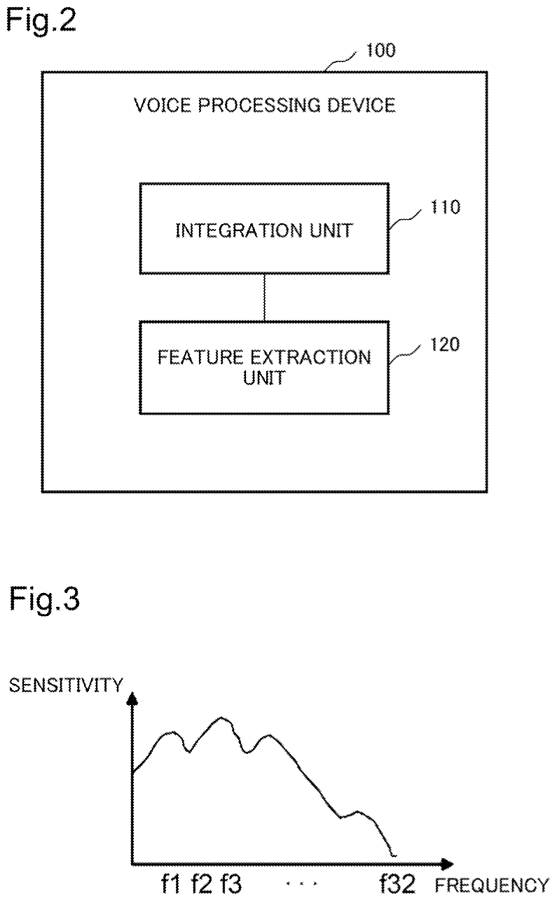

The voice processing device 100 will be described as the first example embodiment with reference to FIGS. 2 to 6.

### Speech Processing Device 100

A configuration of the voice processing device 100 according to the present first example embodiment will be described with reference to FIG. 2. FIG. 2 is a block diagram illustrating a configuration of the voice processing device 100. As illustrated in FIG. 2, the voice processing device 100 includes an integration unit 110 and a feature extraction unit 120.

The integration unit 110 integrates the voice data input by using one or a plurality of input devices and the frequency response of the input device. The integration unit 110 is an example of an integration means.

In one example, the integration unit 110 acquires voice data (registered voice data or voice data for verification in FIG. 1) and information for verifying an input device used for inputting the voice data. The integration unit 110 extracts the acoustic feature from the voice data. For example, the acoustic feature may be a Mel-Frequency Cepstrum Coefficients (MFCC) or a linear predictive coding (LPC) coefficient, or may be a power spectrum or a spectral envelope. Alternatively, the acoustic feature may be a feature vector (hereinafter, referred to as an acoustic vector) of any dimension including a feature amount obtained by frequency analysis of the voice data. In one example, the acoustic vector indicates the frequency response of the voice data.

The integration unit 110 acquires data regarding the input device from the DB (FIG. 1) by using information for verifying the input device. Specifically, the integration unit 110 acquires data indicating the frequency dependence (referred to as frequency response) of the sensitivity of the input device.

FIG. 3 is a graph illustrating an example of the frequency response of an input device. In the graph illustrated in FIG. 3, the vertical axis represents sensitivity (dB), and the horizontal axis represents frequency (Hz). The integration unit 110 extracts the device feature from the data of the frequency response of the input device.

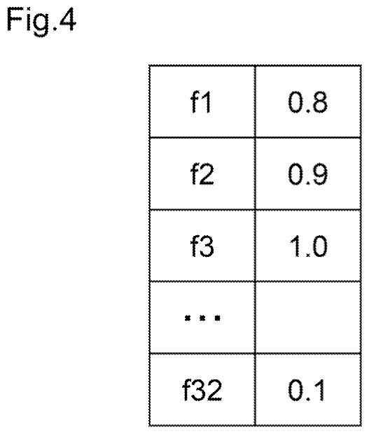

FIG. 4 illustrates an example of the device feature. In the example illustrated in FIG. 4, the device feature is a characteristic vector F (an example of the device feature) indicating the frequency response of the sensitivity of the input device. The characteristic vector F has, as an element (f1, f2, f3, . . . , f32), an average value obtained by integrated the sensitivity (FIG. 3) of the input device in a band of frequencies for each frequency bin (a band having a predetermined width including frequency bins) and dividing the integrated value by the bandwidth.

The integration unit 110 concatenates the acoustic feature thus obtained and the device feature to obtain the integrated feature based on the voice data for verification and integrated feature based on the registered voice data. As described regarding the voice authentication system 1, the integrated feature is one feature vector that depends on both the frequency response of the registered voice data/voice data for verification and the frequency response of the sensitivity of the input device used to input the registered voice data/voice data for verification. As described above, the integrated feature includes the first parameter regarding the frequency response of the registered voice data/voice data for verification and the second parameter regarding the frequency response of the sensitivity of the input device used to input the registered voice data/voice data for verification. An example of the processing and the integrated feature related to the details of integration will be described in the second example embodiment. The integration unit 110 outputs the integrated feature thus obtained to the feature extraction unit 120.

The feature extraction unit 120 extracts speaker features (speaker features A and B) for verifying the speaker of voice from the integrated feature obtained by integrating the voice data and the frequency response. The feature extraction unit 120 is an example of a feature extraction means.

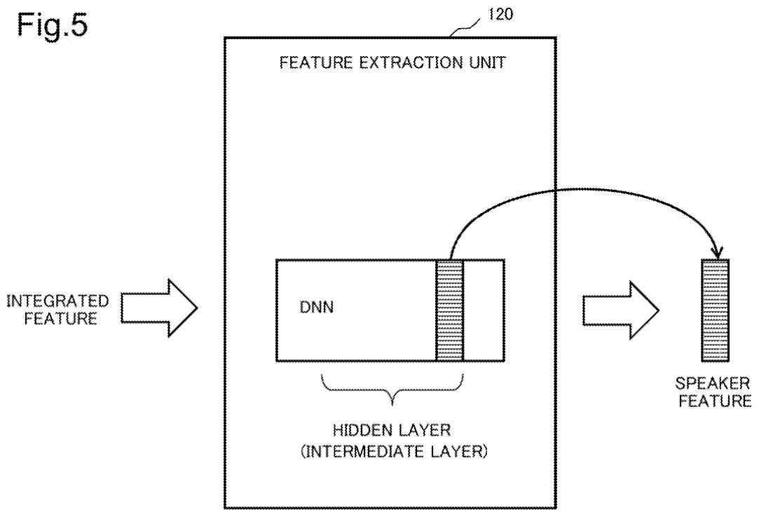

An example of processing in which the feature extraction unit 120 extracts the speaker feature from the integrated feature will be described with reference to FIG. 5. As illustrated in FIG. 5, the feature extraction unit 120 includes a deep neural network (DNN).

In the learning phase, the feature extraction unit 120 inputs training data and updates each parameter of the DNN based on any loss function so that an output result matches correct answer data. The correct answer data is data indicating a correct answer of the speaker. The DNN completes the learning so that the speaker can be verified based on the integrated feature before the phase for extracting the speaker feature.

The feature extraction unit 120 inputs the integrated feature to the DNN that has learned. The DNN of the feature extraction unit 120 verifies the speaker (for example, the person A or the person B) using the input integrated feature. The feature extraction unit 120 extracts the speaker feature of interest of the DNN that has learned.

Specifically, the feature extraction unit 120 extracts, from a hidden layer of the DNN, the speaker feature of interest for verifying the speaker. In other words, the feature extraction unit 120 extracts the speaker feature for verifying the speaker of voice using the integrated feature obtained by integrating the voice data and the frequency response and the DNN. Therefore, the speaker feature is acquired based on the acoustic feature and the device feature, so that the speaker feature does not depend on the frequency response of the input device. Therefore, the verification device 10 can verify the speaker based on the speaker feature regardless of whether the same input device (having the same frequency response) or different input devices (having different frequency response) are used at the time of registration and at the time of verification.

### Operation of Speech Processing Device 100

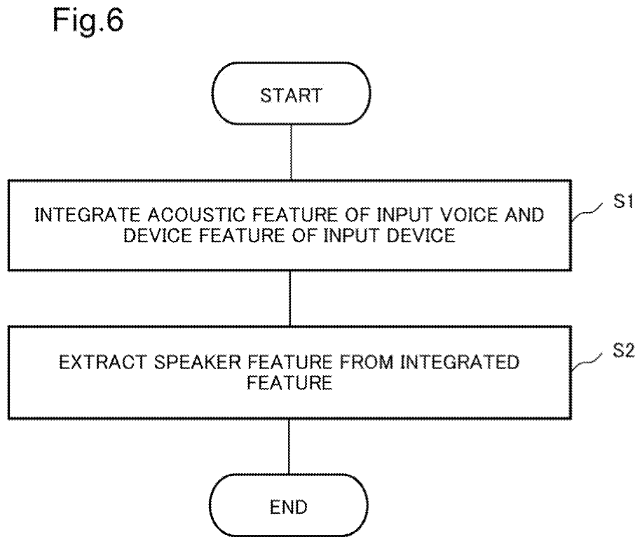

An operation of the voice processing device 100 according to the present first example embodiment will be described with reference to FIG. 6. FIG. 6 is a flowchart illustrating a flow of processing executed by each unit of the voice processing device 100.

As illustrated in FIG. 6, the integration unit 110 integrates the voice data (acoustic feature) input by using the input device and the frequency response (device feature) of the input device (51). The integration unit 110 outputs the data of the integrated feature obtained as a result of step 51 to the feature extraction unit 120.

The feature extraction unit 120 receives, from the integration unit 110, data of the integrated feature obtained by integrating the voice data and the frequency response. The feature extraction unit 120 extracts the speaker feature from the received integrated feature (S2).

The feature extraction unit 120 outputs data of the speaker feature obtained as a result of step S2. In one example, the feature extraction unit 120 transmits the data of the speaker feature to the verification device 10 (FIG. 1). Also at the time of learning of the DNN described above, the voice processing device 100 obtains the data of the speaker feature according to the procedure described here, and stores the data of the speaker feature associated with the information for verifying the speaker as training data in a training DB (training database), which is not illustrated. The DNN described above performs learning for verifying the speaker using the training data stored in the training DB.

Thus, the operation of the voice processing device 100 according to the present first example embodiment ends.

### Effects of the Present Example Embodiment

With the configuration of the present example embodiment, the integration unit 110 integrates the voice data input using the input device and the frequency response of the input device, and the feature extraction unit 120 extracts, from the integrated feature obtained by integrating the voice data and the frequency response, the speaker feature for verifying the speaker of the voice. The speaker feature includes not only information related to the acoustic feature of the voice input using the input device but also the information related to the frequency response of the input device. Therefore, the verification device 10 of the voice authentication system 1 can perform the speaker verification with high accuracy based on the speaker feature regardless of the difference between the input device used to input the voice at the time of registration and the input device used to input the voice at the time of verification.

However, it is desirable that the input device used to input the voice at the time of registration has sensitivity in a wide band as compared with the input device used to input the voice at the time of verification. More specifically, the use band (band having sensitivity) of the input device used to input the voice at the time of registration desirably includes the use band of the input device used to input the voice at the time of verification.

### Second Example Embodiment

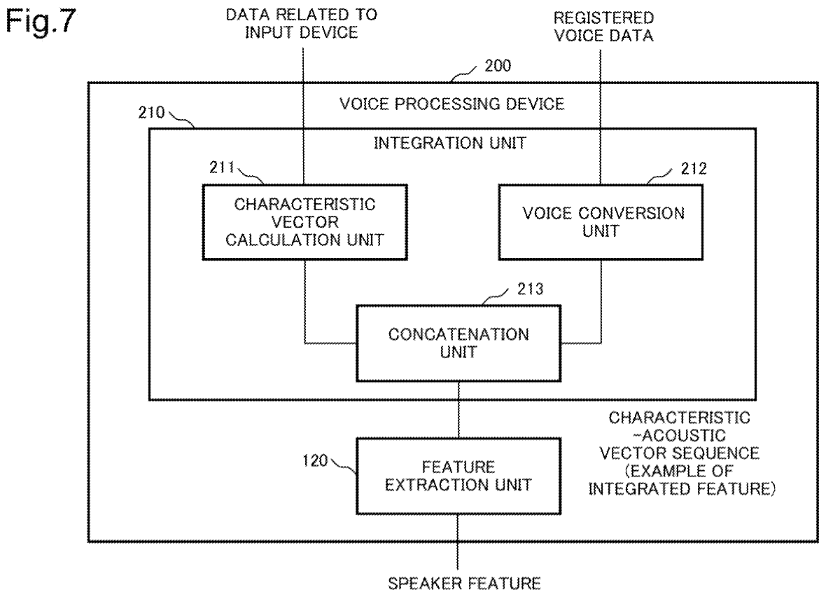

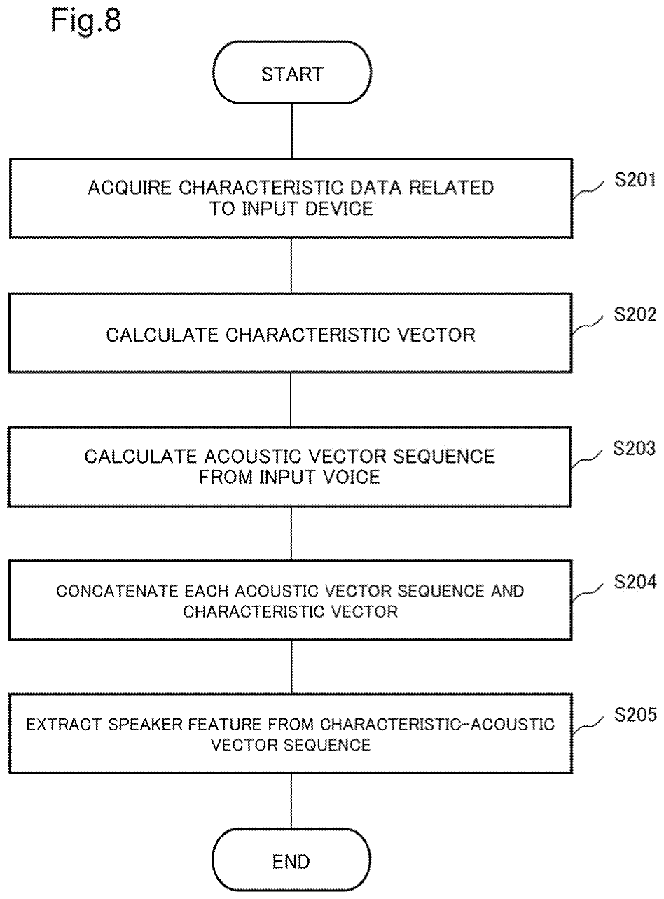

The voice processing device 200 will be described as the second example embodiment with reference to FIGS. 7 to 8.

### Speech Processing Device 200

A configuration of the voice processing device 200 according to the present second example embodiment will be described with reference to FIG. 7. FIG. 7 is a block diagram illustrating a configuration of the voice processing device 200. As illustrated in FIG. 7, the voice processing device 200 includes an integration unit 210 and a feature extraction unit 120.

The integration unit 210 integrates the voice data input by using the input device and the frequency response of the input device. The integration unit 210 is an example of an integration means. As illustrated in FIG. 7, the integration unit 210 includes a characteristic vector calculation unit 211, a voice conversion unit 212, and a concatenating unit 213.

The characteristic vector calculation unit 211 calculates, for each frequency bin, an average value of the sensitivity of the input device in a band of frequencies (a band having a predetermined width including frequency bins), and sets the average value calculated for each frequency bin as an element of the characteristic vector (an example of the device feature). The characteristic vector indicates the frequency response unique to the input device. The characteristic vector calculation unit 211 is an example of a characteristic vector calculation means.

In one example, the characteristic vector calculation unit 211 of the integration unit 210 acquires data related to the input device from the DB (FIG. 1) or an input unit, which is not illustrated. The data related to the input device includes the information for verifying the input device and the data indicating the sensitivity of the input device. The characteristic vector calculation unit 211 calculates, for each frequency bin, an average value of the sensitivity of the input device in a band of frequencies (a band having a predetermined width including frequency bins) from the data indicating the sensitivity of the input device. Next, the characteristic vector calculation unit 211 calculates the characteristic vector having the average value of the sensitivity for each frequency bin as an element. Then, the characteristic vector calculation unit 211 transmits the data of the calculated characteristic vector to the concatenating unit 213.

The voice conversion unit 212 obtains an acoustic vector sequence (an example of the acoustic feature) by converting the voice data from the time domain to the frequency domain. Here, the acoustic vector sequence represents the time series of the acoustic vector for each predetermined time width. The voice conversion unit 212 is an example of a voice conversion means.

In one example, the voice conversion unit 212 of the integration unit 210 receives the voice data for verification from the input device, and acquires the registered voice data from the DB. The voice conversion unit 212 performs a fast Fourier transform (FFT) to convert the voice data into amplitude spectrum data for each predetermined time width.

Further, the voice conversion unit 212 may divide the amplitude spectrum data for each predetermined time width for each predetermined frequency band using a filter bank.

The voice conversion unit 212 obtains a plurality of feature amounts from the amplitude spectrum data for each predetermined time width (or those obtained by dividing it for each predetermined frequency band using a filter bank). Then, the voice conversion unit 212 generates an acoustic vector including a plurality of feature amounts acquired. In one example, the feature amount is the acoustic intensity for each predetermined frequency range. In this way, the voice conversion unit 212 obtains the time series of the acoustic vector (hereinafter, referred to as an acoustic vector sequence) for each predetermined time width. Then, the voice conversion unit 212 transmits the data of the calculated acoustic vector sequence to the concatenating unit 213.

The concatenating unit 213 obtains a characteristic-acoustic vector sequence (an example of the integrated feature) by “concatenating” the acoustic vector sequence (an example of the acoustic feature) and the characteristic vector (an example of the device feature).

In one example, the concatenating unit 213 of the integration unit 210 receives the characteristic vector data from the characteristic vector calculation unit 211. The concatenating unit 213 receives the data of the acoustic vector sequence from the voice conversion unit 212.

Then, the concatenating unit 213 expands the dimension of each acoustic vector of the acoustic vector sequence and adds the element of the characteristic vector as the element of the acoustic vector obtained by expanding each dimension of the acoustic vector sequence.

The concatenating unit 213 outputs the data of the characteristic-acoustic vector sequence thus obtained to the feature extraction unit 120.

The feature extraction unit 120 extracts the speaker feature for verifying the speaker of the voice from the characteristic-acoustic vector sequence (an example of the integrated feature) obtained by concatenating the acoustic vector sequence (an example of the acoustic feature) and the characteristic vector (an example of the device feature). The feature extraction unit 120 is an example of a feature extraction means.

In one example, the feature extraction unit 120 receives the characteristic-acoustic vector sequence data from the concatenating unit 213 of the integration unit 210. The feature extraction unit 120 inputs the characteristic-acoustic vector sequence data to the DNN that has learned (FIG. 5). The feature extraction unit 120 acquires the integrated feature based on the characteristic-acoustic vector sequence from the hidden layer of the DNN that has learned. The integrated feature is a feature extracted from the characteristic-acoustic vector sequence.

The feature extraction unit 120 outputs the data of the integrated feature based on the characteristic-acoustic vector sequence to the verification device 10 (FIG. 1).

### Modification

In the present modification, the acoustic vector (speaker feature A) at the time of registration and the acoustic vector (speaker feature B) at the time of verification are compared in a common part of effective bands in which both the input device used at the time of verification and the input device used at the time of registration have sensitivity.

The characteristic vector calculation unit 211 according to the present modification obtains a third characteristic vector by combining (to be described below) a first characteristic vector indicating the frequency response of the sensitivity of an input device A and a second characteristic vector indicating the frequency response of the sensitivity of an input device B.

The characteristic vector calculation unit 211 according to the present modification outputs the data of the third characteristic vector thus calculated to the concatenating unit 213.

The concatenating unit 213 multiplies each of the acoustic vector (an example of the speaker feature A) at the time of registration and the acoustic vector (an example of the speaker feature B) at the time of verification by the third characteristic vector obtained by combining the two characteristic vectors.

In a band in which at least one of the input device used at the time of verification and the input device used at the time of registration has no sensitivity, a value of the third characteristic vector is zero. Therefore, the value of the acoustic vector multiplied by the third characteristic vector is also zero except for the common part of the effective bands in which the two input devices have sensitivity.

In this way, the effective band of the speaker feature A and the effective band of the speaker feature B are the same. Thus, the verification device 10 (FIG. 1) can compare the speaker feature A and the speaker feature B having the same effective band.

The combination of the two characteristic vectors in the present modification will be described in more detail. The characteristic vector calculation unit 211 compares an n-th element (fn) of the first characteristic vector with a related element (gn) of the second characteristic vector. Then, the characteristic vector calculation unit 211 sets a smaller one of these two elements (fn, gn) as a related element of the third characteristic vector. Alternatively, the characteristic vector calculation unit 211 may set a geometric mean √ (fn×gn) of the n-th element (fn) of the first characteristic vector and the related element (gn) of the second characteristic vector as an n-th element of the third characteristic vector. Alternatively, the characteristic vector calculation unit 211 may input the first characteristic vector and the second characteristic vector to a DNN, which is not illustrated, and extract, from a hidden layer of the DNN, a third characteristic vector in which a value of zero is weighted to a component other than the common part of the effective bands of both the first characteristic vector and the second characteristic vector.

### Operation of Speech Processing Device 200

An operation of the voice processing device 200 according to the present second example embodiment will be described with reference to FIG. 8. FIG. 8 is a flowchart illustrating a flow of processing executed by the voice processing device 200.

As illustrated in FIG. 8, the characteristic vector calculation unit 211 of the integration unit 210 acquires data related to the input device from the DB (FIG. 1) or an input unit, which is not illustrated (S201). The data related to the input device includes the information for verifying the input device and the data indicating the frequency response (FIG. 3) of the input device.

The characteristic vector calculation unit 211 calculates, for each frequency bin, an average value of the sensitivity of the input device in a band of frequencies (a band having a predetermined width including frequency bins) from the data indicating the frequency response of the input device. The characteristic vector calculation unit 211 calculates the characteristic vector having the calculated average value of the sensitivity for each frequency bin as an element (S202). Then, the characteristic vector calculation unit 211 transmits the data of the calculated characteristic vector to the concatenating unit 213.

The voice conversion unit 212 executes frequency analysis on the voice data using the filter bank to obtain amplitude spectrum data for each predetermined time width. The voice conversion unit 212 calculates the above-described acoustic vector sequence from the amplitude spectrum data for each predetermined time width (S203). Then, the voice conversion unit 212 transmits the data of the calculated acoustic vector sequence to the concatenating unit 213.

The concatenating unit 213 concatenates the acoustic vector sequence (an example of the acoustic feature) based on the voice data input using the input device and the characteristic vector (an example of the device feature) related to the frequency response of the input device to calculate the characteristic-acoustic vector sequence (an example of the integrated feature) (S204). The concatenating unit 213 outputs the data of the characteristic-acoustic vector sequence thus obtained to the feature extraction unit 120.

The feature extraction unit 120 receives the characteristic-acoustic vector sequence data from the concatenating unit 213 of the integration unit 210. The feature extraction unit 120 extracts the speaker feature from the characteristic-acoustic vector sequence (S205). Specifically, the feature extraction unit 120 extracts the speaker feature A (FIG. 1) from the characteristic-acoustic vector sequence based on the registered voice data, and extracts the speaker feature B (FIG. 1) from the characteristic-acoustic vector sequence based on the voice data for verification.

The feature extraction unit 120 outputs data of the speaker feature thus obtained. In one example, the feature extraction unit 120 transmits the data of the speaker feature to the verification device 10 (FIG. 1).

Thus, the operation of the voice processing device 200 according to the present second example embodiment ends.

### Effects of the Present Example Embodiment

With the configuration of the present example embodiment, the integration unit 210 integrates the voice data input using the input device and the frequency response of the input device, and the feature extraction unit 120 extracts, from the integrated feature obtained by integrating the voice data and the frequency response, the speaker feature for verifying the speaker of the voice. The speaker feature includes not only information related to the acoustic feature of the voice input using the input device but also the information related to the frequency response of the input device. Therefore, the verification device 10 of the voice authentication system 1 can perform the speaker verification with high accuracy based on the speaker feature regardless of the difference between the input device used to input the voice at the time of registration and the input device used to input the voice at the time of verification.

More specifically, the integration unit 210 includes the characteristic vector calculation unit 211 that calculates an average value of the sensitivity of the input device for each frequency bin and uses the average value calculated for each frequency bin as an element of the characteristic vector. The characteristic vector indicates the frequency response of the input device.

The integration unit 210 includes the voice conversion unit 212 that obtains the acoustic vector sequence by performing Fourier transform on the voice from the time domain to the frequency domain using the filter bank. The integration unit 210 includes the concatenating unit 213 that obtains the characteristic-acoustic vector sequence by concatenating the acoustic vector sequence and the characteristic vector. Thus, it is possible to obtain the characteristic-acoustic vector sequence in which the acoustic vector sequence that is an acoustic feature and the characteristic vector that is a device feature are concatenated.

The feature extraction unit 120 can obtain the speaker feature based on the characteristic-acoustic vector sequence. Therefore, as described above, the verification device 10 of the voice authentication system 1 can perform the speaker verification with high accuracy based on the speaker feature.

### Hardware Configuration

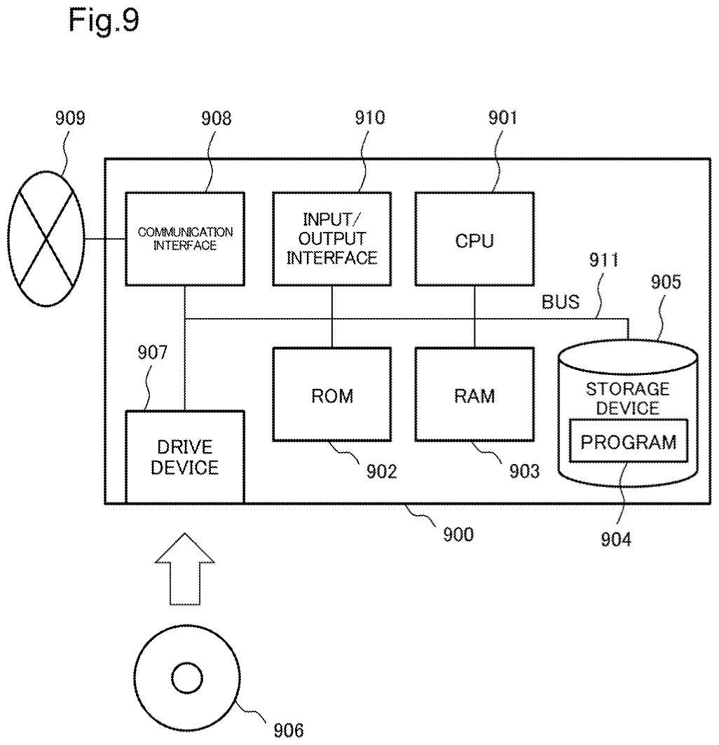

Each component of the voice processing devices 100 and 200 described in the first and second example embodiments represents a block on a function basis. Some or all of these components are achieved by an information processing device 900 as illustrated, for example, in FIG. 9. FIG. 9 is a block diagram illustrating an example of a hardware configuration of the information processing device 900.

As illustrated in FIG. 9, the information processing device 900 includes the configuration described below as an example.
Central processing unit (CPU) 901
Read only memory (ROM) 902
Random access memory (RAM) 903
Program 904 loaded into the RAM 903
Storage device 905 storing the program 904
Drive device 907 that reads and writes with respect to a recording medium 906
Communication interface 908 connected to a communication network 909
Input/output interface 910 for inputting/outputting data
Bus 911 connecting the components

The components of the voice processing devices 100 and 200 described in the first and second example embodiments are achieved by the CPU 901 reading and executing the program 904 that achieves these functions. The program 904 for achieving the function of each component is stored in the storage device 905 or the ROM 902 in advance, for example, and the CPU 901 loads the program 904 into the RAM 903 and executes the program 904 as necessary. The program 904 may be supplied to the CPU 901 via the communication network 909, or may be stored in advance in the recording medium 906, and the drive device 907 may read the program and supply the program to the CPU 901.

With the above configuration, the voice processing devices 100 and 200 described in the first and second example embodiments are achieved as hardware. Therefore, effects similar to the effects described in the first and second example embodiments can be obtained.

### INDUSTRIAL APPLICABILITY

In one example, the present disclosure can be used in a voice authentication system that performs verification by analyzing voice data input using an input device.

### Reference signs List

1 voice authentication system
10 verification device
100 voice processing device
110 integration unit
120 feature extraction unit
200 voice processing device
210 integration unit
211 characteristic vector calculation unit
212 voice conversion unit

What is claimed is:

1. A voice processing device comprising:
a memory configured to store instructions; and
at least one processor configured to run the instructions to perform:
integrating a first feature of voice data input by using an input device and a second feature of a frequency response of the input device; and
extracting a speaker feature for identifying a speaker of the voice data from an integrated feature obtained by integrating the first feature of the voice data and the second feature of the frequency response.

2. The voice processing device according to claim 1, wherein
at least one processor is configured to run the instructions to perform
frequency conversion on the voice data to obtain an acoustic vector sequence that is a time series of an acoustic vector indicating a frequency response of the voice data input from the input device.

3. The voice processing device according to claim 2, wherein
the at least one processor is configured to run the instructions to perform:
calculating an average value of sensitivity of the input device for each frequency bin, and uses the average value of the sensitivity calculated for each frequency bin as an element of a characteristic vector indicating the frequency response of the input device.

4. The voice processing device according to claim 3, wherein
the at least one processor is configured to run the instructions to perform:
obtaining the characteristic vector by concatenating two characteristic vectors for two input devices used at time of registration and at time of verification of a speaker.

5. The voice processing device according to claim 3, wherein
the integrated feature is a characteristic-acoustic vector sequence, wherein the acoustic vector sequence that is an acoustic feature and the characteristic vector that is the device feature are concatenated, and
the at least one processor is configured to run the instructions to perform:
concatenating the acoustic vector sequence and the characteristic vector to obtain the characteristic-acoustic vector sequence.

6. The voice processing device according to claim 1, wherein
the at least one processor is configured to run the instructions to perform:
inputting the integrated feature to a deep neural network (DNN) and obtains the speaker feature from a hidden layer of the DNN.

7. A voice processing method comprising:
integrating a first feature of voice data input by using an input device and a second feature of a frequency response of the input device; and
extracting a speaker feature for identifying a speaker of the voice data from an integrated feature obtained by integrating the first feature of the voice data and the second feature of the frequency response.

8. A non-transitory recording medium storing a program for causing a computer to execute:
processing of integrating a first feature of voice data input by using an input device and a second feature of a frequency response of the input device; and
processing of extracting a speaker feature for identifying a speaker of the voice data from an integrated feature obtained by integrating the first feature of the voice data and the second feature of the frequency response.

9. (canceled)
